(19) United States
(12) Patent Application Publication
(10) Pub. No.: US 2025/0047028 A1
(43) Pub. Date: Feb. 6, 2025

(54) ELECTRICAL CIRCULAR CONNECTOR COMPRISING AN INSULATING BODY AND CONTACT ELEMENT SECURING

(71) Applicant: HARTING ELECTRIC STIFTUNG & CO. KG, Espelkamp (DE)

(72) Inventors: Stefan WATTENBERG, Bad Salzuflen (DE); Sergej HÄMMERLING, Bohmte (DE)

(21) Appl. No.: 18/709,001

(22) PCT Filed: Oct. 31, 2022
(86) PCT No.: PCT/DE2022/100803

§ 371 Date: May 9, 2024

(30) Foreign Application Priority Data
Nov. 12, 2021 (DE) 10 2021 129 501.7

(51) Int. Cl. H01R 13/436; H01R 13/502

(52) U.S. Cl. CPC H01R 13/436; H01R 13/502

(57) ABSTRACT

An electrical circular connector is provided including a housing for accommodating an insulating body that has a substantially cylindrical outer shape, wherein the body is designed to accommodate at least one contact element and can be brought into engagement with at least one locking element which secures the contact element, at least in the axial direction, in its position in the insulating body, and wherein the locking element is integrally joined to the insulating body and, in a locked position, substantially fits into the cylindrical outer shape of the insulating body.

### BACKGROUND

### Technical Field

Embodiments of the present disclosure relate to an electrical circular connector including an insulating body and a contact securing which can be engaged with the insulating body and which enables simplified positioning and fixing of electrical contact elements in the insulating body.

A circular connector including such an insulating body is used to arrange electrical contact elements to be inserted into a connector in contact chambers provided for this purpose with a precise fit and almost without force and to fix them in these chambers.

### Description of the Related Art

The document DE 10 2009 010 492 B3 discloses a connector with a cable-organizing insert for a simplified arrangement of electrical strands within a connector housing and for ensuring a sufficient cable length of the electrical strands with electrical contacts to be attached thereto, wherein a cable-organizing insert in the form of a cable manager is provided within the connector housing for accommodating the electrical strands in an organized manner, in that an axially aligned longitudinal pin is integrally formed on the cable manager, and in that a contact carrier for the electrical strands with electrical contacts attached thereto is provided inside the connector housing, wherein at least one electrical strand is arranged in the center of the contact carrier formed from two half-shells.

The disadvantage of a connector with cable manager is that it is more difficult to automatically equip the connector or an insulating body arranged in the connector.

### BRIEF SUMMARY

The present disclosure provides a connector with an insulating body which can be equipped with contact elements without great effort and which allows the contact elements to be secured in position in the insulating body of the connector in a simple and quick manner.

The electrical circular connector described herein includes a housing which is provided for accommodating an insulating body, wherein the insulating body has a substantially cylindrical outer shape. The insulating body is designed to accommodate at least one contact element and can be brought into engagement with at least one locking element. The locking element is designed here to secure the contact element, at least in the axial direction, in its position in the insulating body. The present disclosure is based here on the locking element, which is arranged in an integrally bonded manner on the insulating body and, in a locked position, substantially fits into the cylindrical outer shape of the insulating body. This means that the locking element does not have a significant protrusion from the cylindrical outer shape in the locked state, which has a negative effect on the insertion into the housing of the circular connector.

In one embodiment, the locking element may be arranged on the insulating body with a living hinge. Living hinges, sometimes also referred to as integral hinges, are comparatively thin and/or thin-walled connections, usually made of plastic, between two components. The design described herein therefore has a thin connection between the insulating body and a locking element. This thin/thin-walled connection allows the locking element to pivot around/on the insulating body. Depending on the material and the material thickness of the living hinge, a one-time use can be achieved. Alternatively, a variety of uses can be cleverly provided.

A further embodiment provides for the insulating body to have at least two regions which are connected by at least one first web element. This means that, on the one hand, the insulating body has at least one plug-in region, which extends from an end on the plug-in side at least as far as a web element. On the other hand, the insulating body has a connection region that extends from a cable to be connected to at least the web element. The region of the web element can be seen as a separate region. Depending on the design, the web element can be assigned to one of the regions of the plug-in region or connection region. Depending on the embodiment, the web element can also be assigned at least partially to both of the regions of the plug-in region or connection region.

Another embodiment provides for the locking element to be arranged on the web element. This means that the at least one locking element is located at the height of the web element. This means that the locking element, like the web element, is located between the insertion region and the connection region of the insulating body. This simplifies the insertion of contact elements located on strands of a cable. Through-openings can thus be provided in the connection region. To simplify the insertion of contact elements, these can be adapted to the shape of the contact elements. Funnel shapes, for example chamfers, can be provided at the edges between the connection region of the insulating body and the through-openings. These shapes make it easier to equip the insulating body with contact elements. Tolerances can be compensated for more easily, such as in the case of automated equipping of the insulator.

In another embodiment, the insulating body may have at least two locking elements. One embodiment here provides for these locking elements to be arranged in substantially the same axial position. These locking elements are arranged on both sides of the web that separates the connection region from the plug-in region. This makes it particularly easy to close the locking elements. There are advantageous possibilities for automated equipping and locking. For example, after an equipping process with the contact elements provided, a downward movement using, for example, a funnel-shaped tool can be used to lock the locking elements on the insulating body. Alternatively, the locking elements can lock each other.

A further embodiment to this end provides for the locking elements to be substantially point-symmetrical. For example, one embodiment provides for the locking elements to be designed so that they can be form-fittingly engaged with one another to secure the contact elements. For example, the locking elements may be designed with a latching hook, which hooks engage in respective latching hooks of the oppositely positioned locking element. Alternatively, the locking elements may engage in shaped elements of the insulating body, such as latching hooks, latching lugs or protrusions.

In another embodiment, the locking elements for securing the contact elements may be designed to engage with each other frictionally. In addition, the insulating body may be designed with frictional engagement elements, for example wedge elements, into which the locking elements, which are also designed as wedges, for example, can be pressed. A combination of form-fit and frictional engagement elements on the insulating body and/or the locking elements can also be used expediently.

In another embodiment, the locking elements in a mutually engaged position rest against a second web element. This second web element may be located between the connection region and the plug-in region of the insulating body. The second web element ensures improved stability of the insulating body. This improved stability has an effect on the insulating body with locking elements that are not yet in a locked position. In addition, the stability of the connector regions in relation to each other is improved. The stability of two locking elements in the locked state can also be increased. For example, the locking elements can thus be brought into engagement with each other or with the second web above, below, in or on the second web.

In one embodiment, the housing may be made of a first material and the insulating body may be made of a second material, wherein the first material is different from the second material. The housing can therefore be made of a metal, while the insulating body is made of a plastic. The housing can also be made of a plastic that differs in its composition and/or its properties from the plastic of the insulating body.

### BRIEF DESCRIPTION OF THE SEVERAL VIEWS OF THE DRAWINGS

Embodiments of the disclosure are shown in the drawings and are explained in greater detail below.

FIG. 1 shows a perspective view of an insulating body with open locking elements.

FIG. 2 shows a view of the connection side of an insulating body with open locking elements and partially occupied contact chambers.

FIG. 3 shows a view of the connection side of an insulating body with open locking elements and fully occupied contact chambers.

FIG. 4 shows a further perspective view of an insulating body with open locking elements.

FIG. 5 shows a perspective view of an insulating body with latched locking elements.

FIG. 6 shows a connector with connected cable, wherein the locking elements of the insulating body are still open.

Some of the Figures contain simplified, schematic representations. In some cases, identical reference signs are used for like, but possibly not identical elements. Different views of like elements may be scaled differently. Directional indications such as “left,” “right,” “top” and “bottom” are to be understood with reference to the figure in question and may vary in the individual illustrations in relation to the object shown.

### DETAILED DESCRIPTION

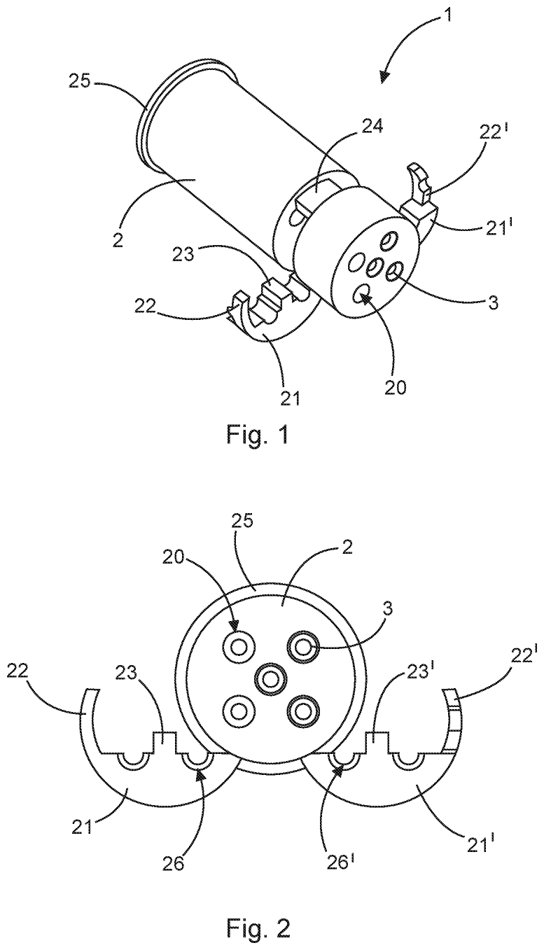

FIGS. 1 to 4 show an insulating body 1 with a substantially cylindrical outer shape 2. The insulating body 1 has two wing-like locking elements 21, 21′. The locking elements 21, 21′ are arranged in an integrally bonded manner on a web element 24′. The insulating body 1 has through-openings 20. The through-openings 20 are intended for contact elements 3 to be inserted into the insulating body 1. This region of the insulating body 1 is referred to as the connection region. Opposite the connection region is the plug-in region, on which a connection flange 25 is located in the embodiment shown. The connection flange 25 protrudes beyond the cylindrical outer shape 2 of the insulating body 1. A connection shape such as the connection flange 25 shown is usually used to insert or fix the insulating body 1 in a connector housing. The locking elements 21 and 21′ each have a contact securing here. The contact securings shown are of different designs. The contact securings for inner contact elements 23 and 23′ are designed as protrusions and, when the locking elements 21 and 21′ are locked, act together on the inside of the contact elements 3 inserted in the through-openings 20. The inner contact securings 23 and 23′ engage here, for example, in a contact region of a contact element 3 between a plug-in region and a connection region and/or a crimping region in order to secure this contact in the axial direction.

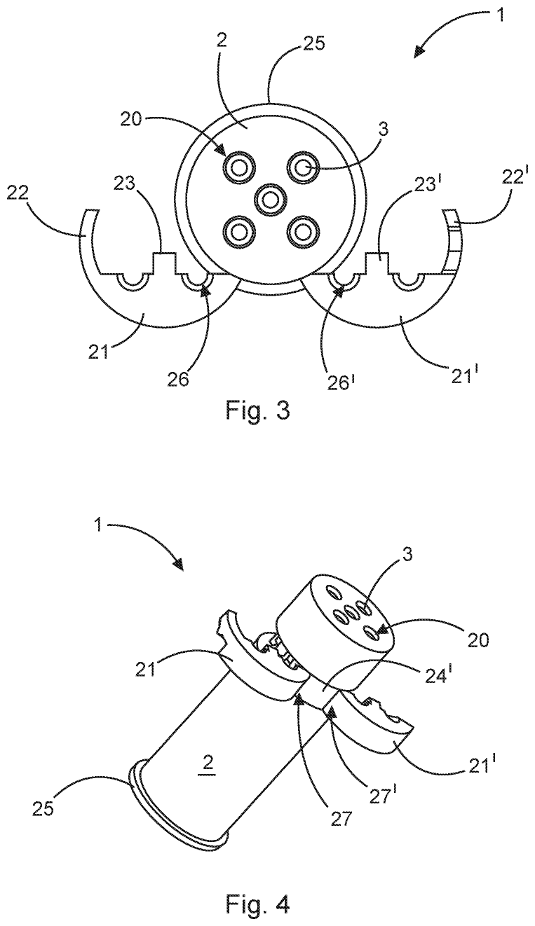

FIGS. 2 and 3 show similar insulating bodies 1 with a cylindrical outer shape 2. The insulating body 1 in FIG. 2 is equipped here with three contact elements 3. The contact elements 3 are inserted in through-holes 20. The insulating body 1 in FIG. 3 is fully equipped with contact elements 3.

FIG. 4 shows the integral bond between the locking elements 21 and 21′ and the web element 24′, which bond is designed as a living hinge 27, 27′. In a connection region of the insulating body 1, i.e., the region into which the contact elements 3 are inserted, the insulating body 1 has a through-opening 20 for each contact element 3 provided. The insulating body 1 shown has two regions that are connected by web elements 24 and 24′. The locking elements 21 and 21′ arranged on the web element 24′ each have a latching element 22 and 22′. These latching elements 22 and 22′ are designed in such a way that they engage with one another when the locking elements 21 and 21′ are locked. Alternatively, the web element 24 can be connected to the web element 24′. This would use a single web element that connects the connection region to the plug-in region of the insulating body 1.

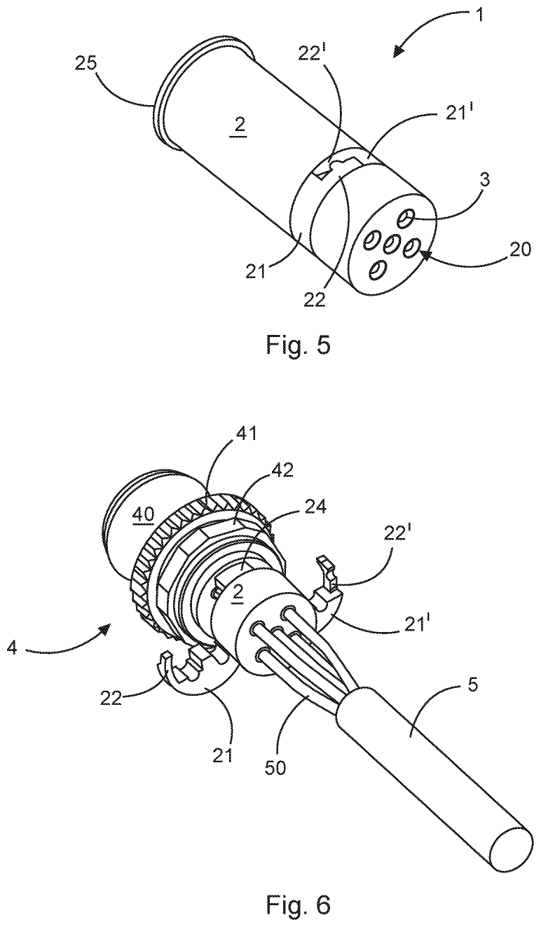

FIG. 5 shows such mutually engaging latching elements 22 and 22′ of the locking elements 21 and 21′. The locking elements 21 and 21′ have different types of latching elements 22 and 22′. In an alternative embodiment, the latching elements 22 and 22′ can be designed to be point-symmetrical. The locking elements 21 and 21′ shown here fit easily and clearly into the cylindrical outer shape 2 of the insulating body 1 in their mutually engaged state.

FIG. 6 provides an impression of a connector 4. Here, a connector 4 with a housing 40 is shown. The connector 4 has a knurl 41. This knurl 41 is usually used in connectors with a thread (not shown) in order to be connected to a corresponding thread of a mating connector (not shown) or a connection housing (not shown). The connector 4 has a fastening shape 42. This is usually used, for example, to connect a sealing cap or a closure cap of a cable gland (not shown) to the housing 40. FIG. 6 also shows an embodiment for the connection of a cable 5 having five strands 50.

Although various aspects or features of the present disclosure are shown in combination in the Figures, it is apparent to a person skilled in the art-unless otherwise stated—that the combinations shown and discussed are not the only possible ones. In particular, corresponding units or feature complexes from different exemplary embodiments can be interchanged with one another.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An electrical circular connector, comprising:
a housing for accommodating an insulating body, wherein the insulating body has substantially a cylindrical outer shape, wherein the insulating body is configured to accommodate at least one contact element, wherein the at least one contact element can be brought into engagement with at least one locking element which secures the at least one contact element, at least in an axial direction, in position in the insulating body, and wherein the locking element is arranged in an integrally bonded manner on the insulating body and, in a locked position, substantially fits into the cylindrical outer shape of the insulating body.

2. The electrical circular connector as claimed in claim 1, wherein the locking element is arranged with a living hinge on the insulating body.

3. The electrical circular connector as claimed in claim 1, wherein the insulating body has at least two regions which are connected by at least one first web element.

4. The electrical circular connector as claimed in claim 3, wherein the locking element is arranged on the at least one first web element.

5. The electrical circular connector as claimed in claim 1, wherein the insulating body has at least two locking elements.

6. The electrical circular connector as claimed in claim 5, wherein each respective locking element is elements arranged in substantially the same axial position.

7. The electrical circular connector as claimed in claim 1, wherein the locking elements are substantially point-symmetrical to one another.

8. The electrical circular connector as claimed in claim 1, wherein the locking elements for securing the contact elements are configured to be able to be brought into engagement with each other form-fittingly.

9. The electrical circular connector as claimed in claim 1, wherein the locking elements for securing the contact elements are configured to be able to be brought into engagement with each other frictionally.

10. The electrical circular connector as claimed in claim 1, wherein the locking elements rest against a second web element in a mutually engaged position.

11. The electrical circular connector as claimed in claim 1, wherein the housing is made of a first material and the insulating body is made of a second material, wherein the first material is different from the second material.
